(19) United States
(12) Patent Application Publication
(10) Pub. No.: US 2010/0228164 A1
(43) Pub. Date: Sep. 9, 2010

(54) Stroke master

(76) Inventor: John Michael McDuffie, Marcoisland, FL (US)

Correspondence Address: JOHN MICHAEL McDUFFIE, 817 WINTERGREEN CT, MARCOISLAND, FL, 34145, US

(21) Appl. No.: 12/380,796

(22) Filed: Mar. 4, 2009

(51) Int. Cl. A61H 1/00

(52) U.S. Cl. 601/27; 601/34

(57) ABSTRACT

The present invention is for the rehabilitation of stroke, brain or nerve damaged patients. Due to a stroke, brain injury or nerve damage a patients feet become paralyzed and unresponsive. The patient must relearn lower leg and foot muscle control. The patient must use their own will, as well as, some force from the pull cords to stimulate, manipulate and reprogram motor skills. Parts A, B, C of the embodiment provide rehabilitative stimulation to the muscles in the lower legs and feet at all angles of deflection. The stroke master rehabilitative invention is designed to help the patients regain mobility by stimulating damaged nerves and muscles through repetition and the sheer will of the patient.

### BACK GROUND OF INVENTION

1. Field of the Invention

The present invention relates to a rehabilitative therapy device more particularly, to a lower leg and foot muscle stimulation device. Due to Stroke, Brain or Nerve damage the patient looses mobility of the manipulative muscles working in the lower legs, and feet. If a patient does not acquire therapy soon after the incident permanent loss of mobility could occur. When used correctly this invention can greatly improve muscle mobility and control. Said invention has three separate parts referred to and shown as Parts, A) B) and C).

2. Description of the Related Art

Parts A) B) C) of the embodiment provide rehabilitative stimulation to the lower leg and foot muscles at all angles of deflection. Left, right, pivotal, up and down motions are operated by the sheer will of the patient, as well as, a gentle leading force from pull cords. This force is needed do to Stroke, Brain or Nerve damage, a patients foot muscles become paralyzed, stiff and unresponsive. Rehabilitation of the lower legs and feet is necessary to regain mobility and reprogram motor skills.

### SUMMARY OF THE INVENTION

The present invention is for the rehabilitation of stroke, brain or nerve damaged patients. Due to a stroke, brain injury or nerve damage a patients feet become paralyzed and unresponsive. The patient must relearn lower leg and foot muscle control. The invention has three separate parts. They are Parts A) B) C) of the embodiment which provide rehabilitative stimulation to the lower leg and foot muscles at all angles of deflection.

Part A). To achieve this and other objectives the Stoke Master invention has a flat plate base on which a foot box sets where the patient's foot is placed. The foot box is secured at the bottom back by a bearing, which allows the foot to swivel or turn left to right and a wheel at the bottom front that enables it to role. Pull cords to pull left and right are attached to the front of the foot box; cords go through pulleys that are fastened to the outer edge of the flat base plate and are grasped by the patient or therapist's hands. A pulling force is applied to the cords as needed to help turn the foot left then right. The patient must relearn lower leg and foot muscle control. The patients alternate foot can remain standing on the plank with similar elevation. Unless patient is in a wheel chair then the movable plank can be removed. The above completes the summery of part A).

Part B). Using the same flat plate base and foot box the foot box is taken off the rear swivel and the front wheel is then placed into an inoperative position. The bottom of the foot box has a movable half round ball underneath it, which is placed on to the flat plate base. The removable pull cords are then attached to the sides of the foot box then grasped by the patient or therapist's hands. A pulling force is applied more to one side than the other this gives the muscles, nerves in the lower leg and foot stimulation. The patient must relearn lower leg and foot muscle control. The patient's alternate foot can remain standing on the plank at a similar elevation. Unless patient is in a wheel chair then the movable plank can be removed. The above completes the summery of Part B).

Part C). Last using the same flat plate base and foot box with the movable half round ball under it, the half round ball is slid backward allowing the front of the foot to drop. The pull cords are then reattached to the front of the foot box and placed in the patients or therapist's hands. A polling force is then applied, pulling straight up as needed to raise the front of the foot. The patient must relearn lower leg and foot muscle control. The patient's alternate foot can remain standing on the plank with similar elevation. Unless patient is in a wheel chair then the movable plank can be removed. The above completes the summery of part C).

### BRIEF DESCRIPTION OF THE DRAWINGS

FIG. 1A is the top view of the stroke master Part A.

FIG. 1B is the side view and a front view of Part A.

FIG. 2A is top view Stroke Master Part B.

FIG. 2B is a side view and a front view of Part B.

FIG. 3A is top view of the Stroke Master Part C.

FIG. 3B is a side view and a front view of Part C.

### DETAILED DESCRIPTION OF THE INVENTION

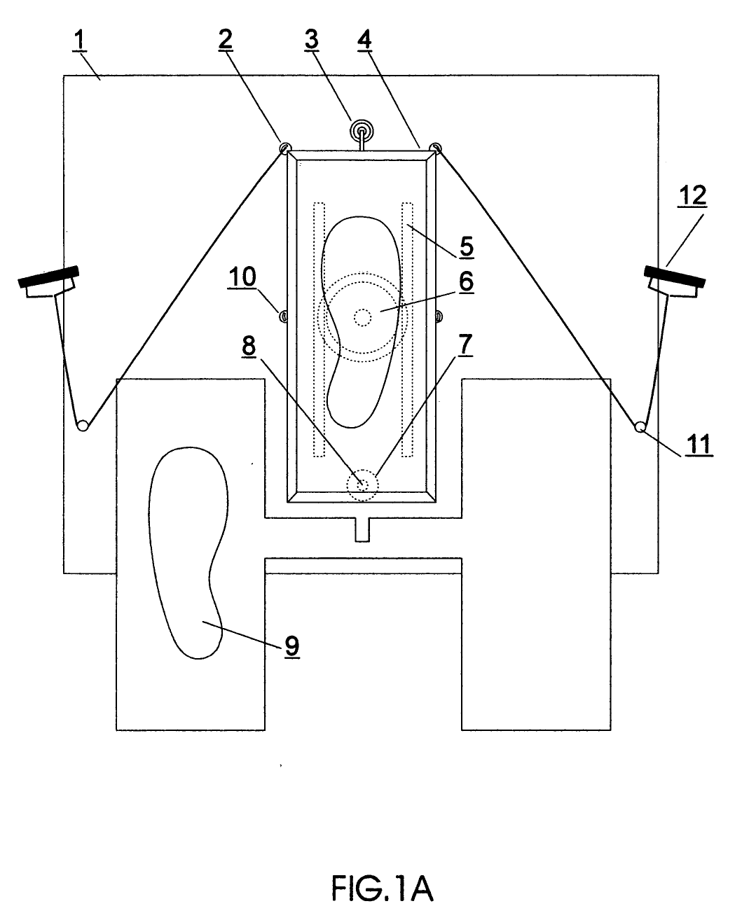

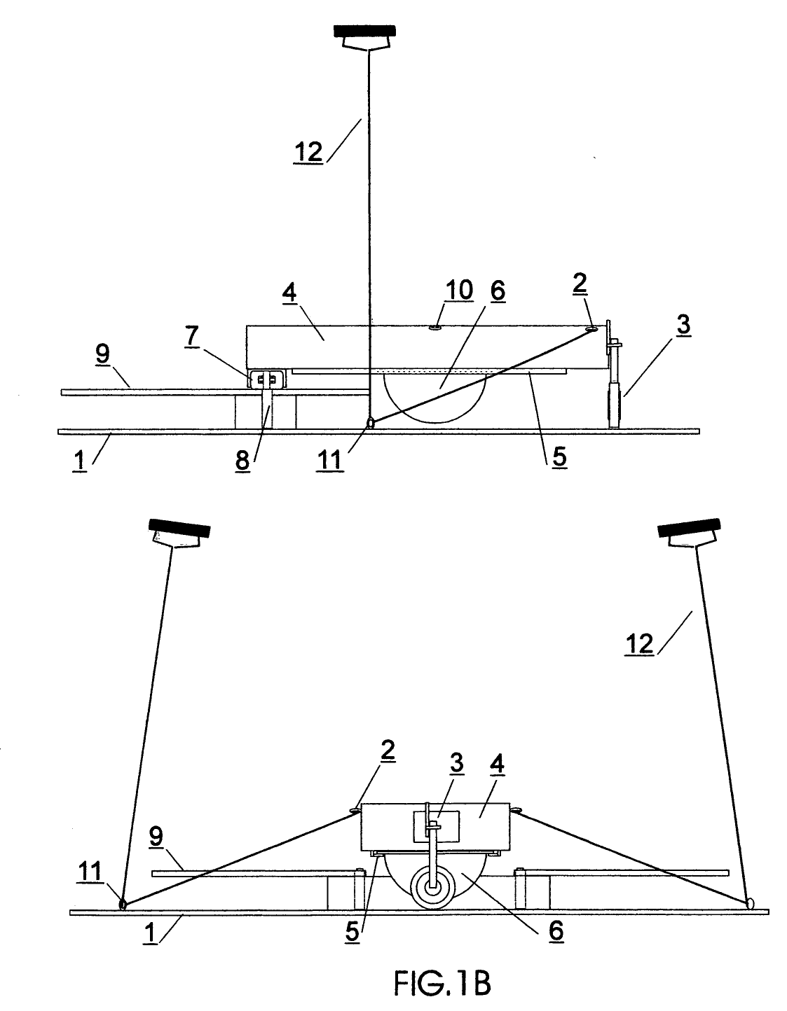

Referring to FIGS. 1A and 1B is operated by pull cords with handles 12 which are attached to the front corners 2 of the foot box 4 and run through pulleys 11 on each side of the flat plate base 1 then up to the patients or therapists hand grips. Patient places foot into foot box 4, which has a female swivel bearing 7 at the back under side. Female bearing slides on and off male shaft 8 fixed to the rear of the main platform 1. A wheel 3 under the front of the foot box allows for side-to-side motion. The Patient's alternate foot can stand on movable foot plank 9. Foot plank 9 can be removed to allow for patients in wheel chairs to use foot box 4. The patient must use their own will, as well as, some force from the pull cords to stimulate and manipulate the foot muscles.

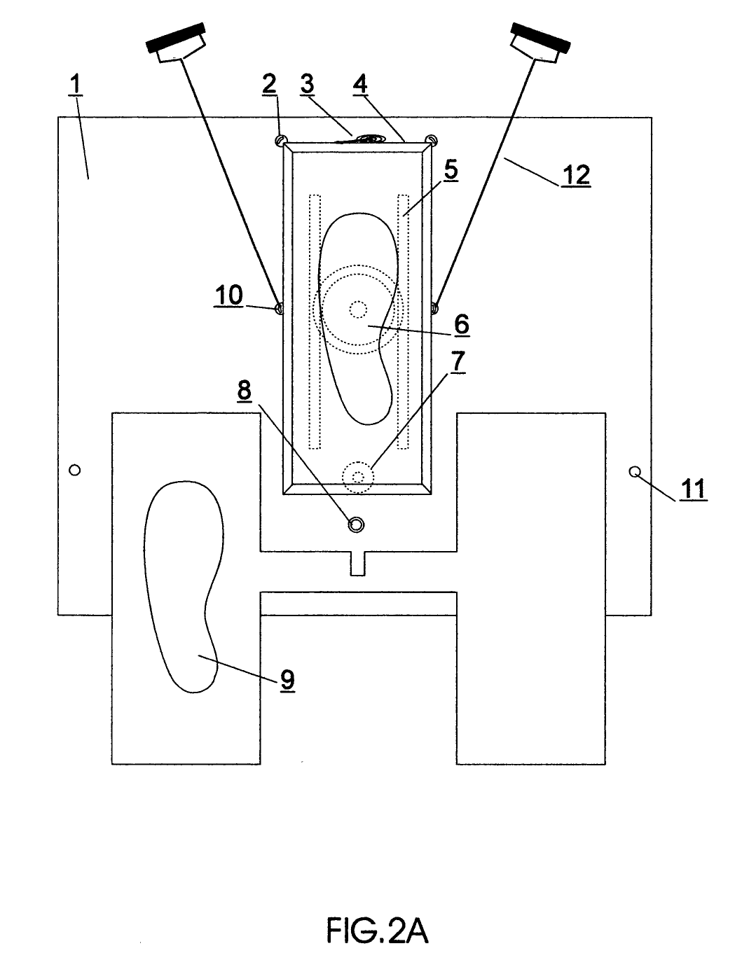

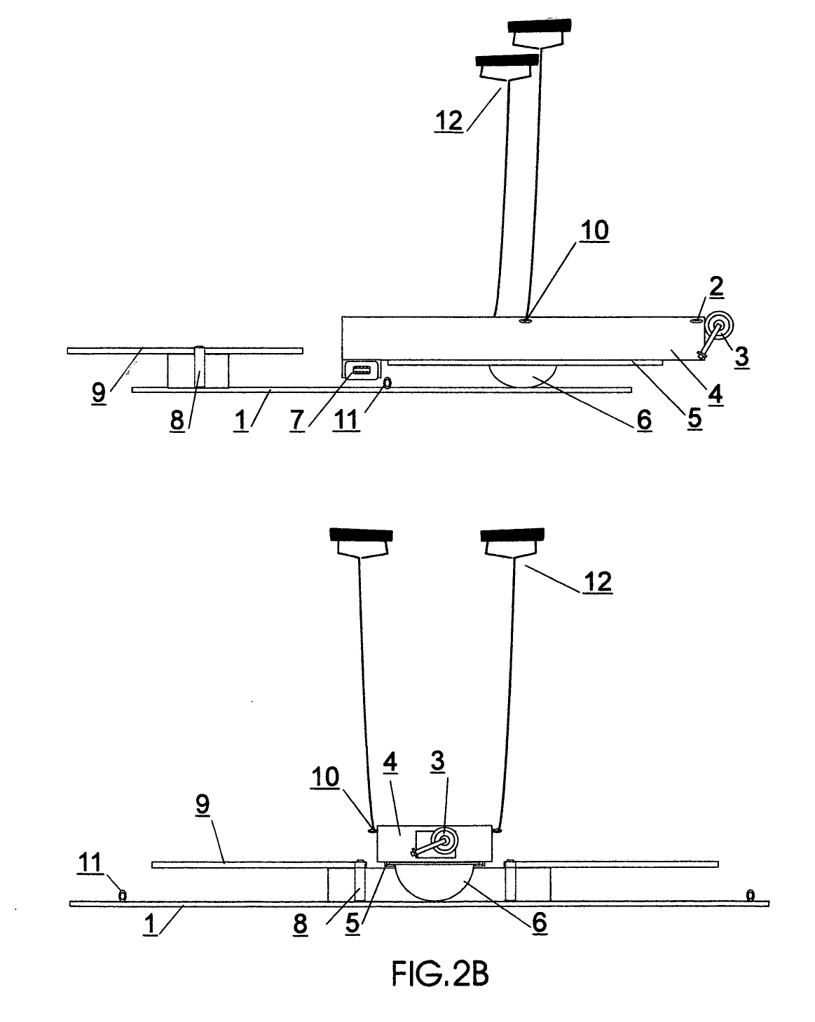

Referring to FIGS. 2A and 2B is operated by pull cords with handles 12 that are attached 10 to the sides of the foot box 4. The foot box 4 is set forward off the rear male shaft 8 and the front wheel 3 on the foot box 4 is raised. The movable half round ball 6 on the under side of foot box 4 is placed onto the flat plate base 1 and the movable half round ball 6 is slid forward to the desired position in slide track 5; so that the foot remains level. The patient places foot in foot box 4, the patient's alternate foot can stand on the movable foot plank 9. Foot plank 9 can be removed to allow for patients in wheel chairs to use foot box 4. The pull cord handles 12 are placed into the patients or to the therapist's hands. A gentle force on the pull cords will allow the patient or therapist to bend the outer edge of the foot down on one side and up on the other. Then the patient or therapist reverses pulling the outer edge of the foot up and the inner side down. The patient must use their own will, as well as, some force from the pull cords to stimulate and manipulate the foot muscles.

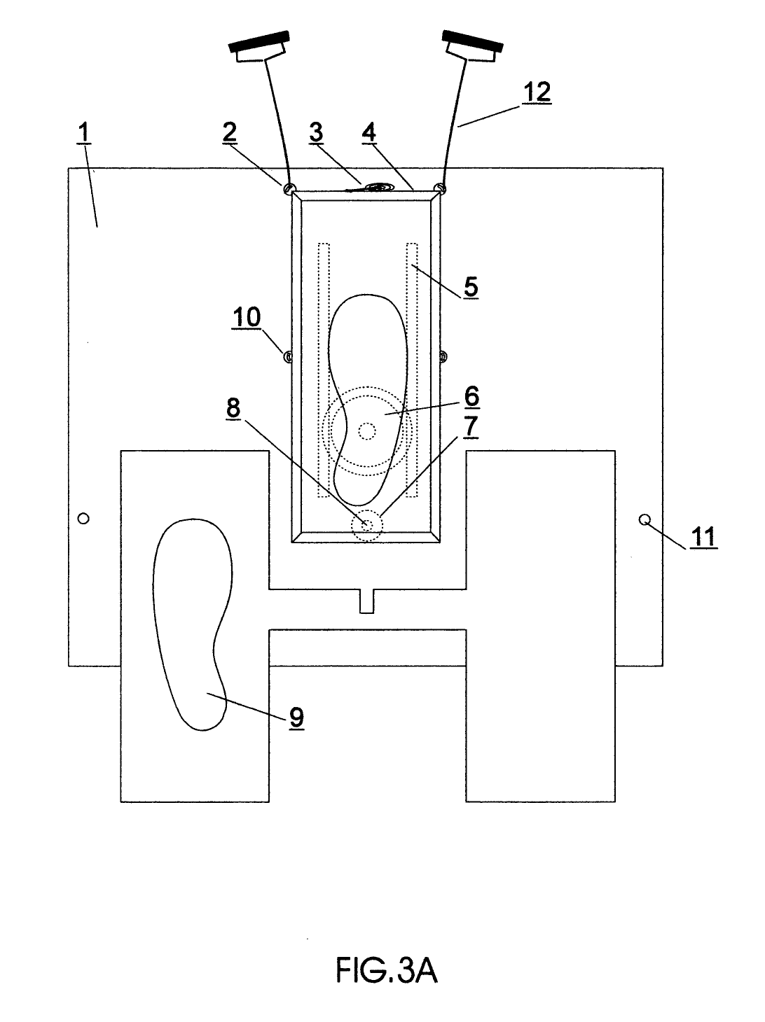

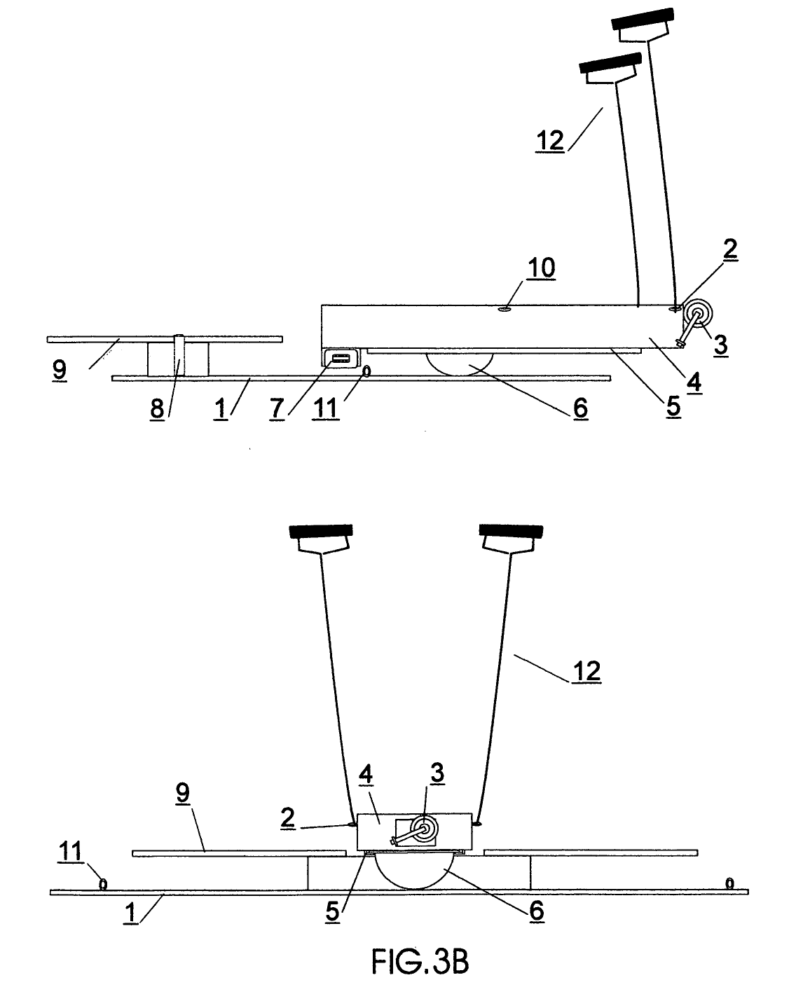

Referring to FIGS. 3A and 3B is operated by pull cords with handles 12 that are attached to the front corners 2 of the foot box 4. The foot box 4 is set forward off the rear male shaft 8 and the front wheel 3 on the foot box 4 is raised. The movable half round ball 6 on the under side of foot box 4 is placed onto the flat plate base 1 and the movable half round ball 6 is slid rear to desired position in the slide track 5; so that the toes or front of the foot box drops. The patient places foot in foot box 4, the patient's alternate foot can stand on the movable foot plank 9. Foot plank 9 can be removed to allow for patients in wheel chairs to use foot box 4. The pull cord handles 12 are placed in the patients or therapists hands. The pull cords help the patient raise the front of the foot box. The patient must use their own will, as well as, some force from the pull cords to stimulate and manipulate the foot muscles.

Particular parts of the invention have been described in detail for the purpose of illustration; however, various modifications and enhancements may be made without departing from the spirit and scope of the invention. Also, the invention is not to be limited except as by the appending claims. The present invention can be used standing, sitting, laying or in a reclined position. Said invention can also be used with electric shock stimulation devices.

The invention claim is:

1. A stroke master is for victims of stroke, brain injury and nerve damage. The patient must relearn lower leg and foot muscle control. The rehabilitative embodiment provides stimulation to the muscles in the lower legs and feet at all angles of deflection and is comprised of Parts A, B, C.
1. Part A: a flat plate base, which has a foot box on top, is affixed together at the rear by a swivel bearing. The foot box has a wheel under the front side, which allows it to roll as it is pulled at the front by the cords from left to right. Patient places their weight on the foot box and gentle force is applied to the pull cords as the patient relearns the left to right motion. The alternate foot can be placed on the foot planks. Unless patient is in a wheel chair then the movable plank can be removed.
2. Part B: a flat plate base, which has a foot box on top, has the rear foot box swivel bearing removed and front wheel is raised. The foot box is set on the half round ball, which is affixed underneath the foot box. The pull cords are attached to the sides while the patient places their weight on the foot box and the ankle begins to bend. A gentle pulling force is applied to the cords as the patient tries to relearn how to stabilize the ankle. The alternate foot can be placed on the foot plank. Unless patient is in a wheel chair then the movable plank can be removed.
3. Part C: a flat plate base, which has a foot box on top, has the rear foot box swivel bearing removed and front wheel is raised. The foot box is set on the half round ball, which is affixed underneath and is slid to the rear position. The pull cords are reattached to the front of the foot box. The patient places their weight on the front of the foot box and the front of the foot drops. A gentle pulling force is applied to the cords to pick the front of the foot up. The patient has to relearn to pick the dropped foot up. The alternate foot can be placed on the foot plank. Unless patient is in a wheel chair then the movable plank can be removed.
